(19) United States
(12) Patent Application Publication
(10) Pub. No.: US 2008/0168927 A1
(43) Pub. Date: Jul. 17, 2008

(54) COMPOSITE MATERIALS FORMED OF AT LEAST PARTIALLY CURED CEMENT-CONTAINING PARTICLES DISPERSED IN A POLYMER, APPLICATIONS OF USING SAME, AND METHODS OF MAKING

(75) Inventor: Stacey Roberts, Poulsbo, WA (US)

Correspondence Address: PERKINS COIE LLP;PATENT-SEA, P.O. BOX 1247, SEATTLE, WA, 98111-1247, US

(73) Assignee: Shear Technologies, Inc., Kingston, WA (US)

(21) Appl. No.: 11/623,035

(22) Filed: Jan. 12, 2007

(51) Int. Cl. C04B 24/10; C04B 14/00

(52) U.S. Cl. 106/731; 264/171.1

(57) ABSTRACT

Composite materials including at least partially cured cement-containing particles dispersed through a polymeric matrix and applications utilizing such composite materials such as a floor tile, decking profile, roof profile, stair tread, railings, siding, and interior and exterior trim. Methods of fabricating the composite materials and products are also disclosed.

### CROSS-REFERENCE TO RELATED APPLICATIONS

This application is a continuation-in-part of U.S. application Ser. No. 11/331,892, filed Jan. 12, 2006, and entitled “Composite Materials Formed Of At Least Partially Cured Cement-Containing Particles Dispersed Through Polymeric Matrix, Applications Using Same, And Methods Of Making, which is incorporated herein by reference.

### TECHNICAL FIELD

This invention generally relates to composite materials including at least partially cured cement-containing particles, such as fiber-cement particles, dispersed in a polymeric matrix, applications using such compositions, and methods of making compositions.

### BACKGROUND

The exteriors of houses and other types of buildings are commonly covered with siding materials that protect the internal structure from external environmental elements. Siding may be made from a variety of materials, including wood, concrete, brick, aluminum, stucco, wood composites, and cement/cellulose composites. Wood siding is popular, but it is costly, flammable, subject to infestation, subject to cracking, and comes from a diminishing resource. Aluminum is also popular, but it is easily deformed, subject to expanding/contracting, and relatively expensive. Brick and stucco siding are popular in certain regions of the country, but they are costly and labor-intensive to install.

Fiber-cement siding offers several advantages compared to other types of siding. Fiber-cement siding is made from a mixture of cement, silica sand, and cellulose fibers. The fiber-cement siding mixture is pressed and then cured to form planks, panels, and boards of finished cement siding. Fiber-cement siding is advantageous because it is non-flammable, weatherproof, not subject to rotting or infestation, and relatively inexpensive to manufacture. Fiber-cement siding is also advantageous because it may be formed with simulated wood grains or other design features that give the appearance of a natural product.

Fiber-cement siding products can also be painted like wood, but they are not made from a valuable natural resource. Therefore, many contractors and manufactured builders are switching to fiber-cement siding products from wood, composites, aluminum, plastic, and bricks. The increased use of fiber-cement siding may help reduce logging in old growth forests in Washington, Oregon, California, and Alaska. Thus, fiber-cement siding is becoming an increasingly popular siding material in many areas of the country.

One challenge of manufacturing fiber-cement siding products is disposing of the waste associated with processing fiber-cement materials. During processing of fiber-cement siding, fiber-cement waste is generated that is currently disposed of in landfills. For example, the waste can be relatively small fiber-cement elements produced by punching fiber-cement panels or planks to produce soffit materials or integrated shake panels. The fiber-cement waste can also be whole or partial panels or planks that do not meet quality control standards for a variety of reasons. The largest supplier of fiber-cement siding, the James Hardie Corporation, generates several thousand tons of fiber-cement waste per year from processing fiber-cement siding. PacTool International, Inc. also generates several thousand tons of fiber-cement waste per year by forming slots for the fiber-cement shake panels as disclosed in U.S. Pat. No. 6,276,107 and punching holes for the fiber-cement soffit as disclosed in U.S. Pat. No. 6,468,453, both of which are incorporated herein by reference. Disposing of fiber-cement waste increases the cost of manufacturing fiber-cement products and requires a significant amount of space.

To mitigate the impact on landfills, several attempts have been made to reincorporate fiber-cement waste back into a fiber-cement product. However, existing fiber-cement products with cured recycled fiber-cement have suffered from several drawbacks. For example, products with recycled cured fiber-cement often have inadequate mechanical properties for many applications. Accordingly, there is a significant need to develop methods and products that use fiber-cement waste generated in the production of fiber-cement siding and other products.

### BRIEF DESCRIPTION OF THE DRAWINGS

FIG. 1 is a flow chart illustrating a method in accordance with an embodiment of the invention.

FIG. 2 is a flow chart illustrating a method in accordance with another embodiment of the invention.

FIG. 3 is a flow chart illustrating a method in accordance with still another embodiment of the invention.

FIG. 4 is a flow chart of a process for recycling fiber-cement waste in accordance with another embodiment of the invention.

FIG. 5 is a schematic, cross-sectional view illustrating a portion of a building product made from a fiber-cement and polymer composite in accordance with an embodiment of the invention.

FIG. 6 is a schematic cross-sectional view of a composite material having cement-containing particles and a polymer in accordance with an embodiment of the invention.

### DETAILED DESCRIPTION

### A. Overview

The invention is directed to composite materials including cured or at least partially cured cement-containing particles dispersed in a matrix material, articles formed from such composite materials, and methods of fabricating such compositions and articles. The cement-containing particles, for example, can be fiber-cement particles that have been fully or partially cured and contain silica, cement and cellulose fibers. The cellulose fibers in the fiber-cement particles are generally chemically treated organic fibers, such as chemically treated wood fibers, as opposed to small wood particles (e.g., wood flour) that have been reduced to small particle sizes without chemical treatments. The composite materials may also optionally include separate wood particles or other filler materials. By dispersing particles formed from fiber-cement waste products or concrete waste products in a polymer matrix material, composite materials may be formed that have desirable engineering properties and provide a solution to the increasing problem of disposal of cement waste products.

One aspect of the invention is directed toward methods for manufacturing fiber-cement and polymer composite materials. An embodiment of such a method includes providing fiber-cement particles composed of silica, cement, and cellulose fibers. The fiber-cement particles are at least partially cured, and in many embodiments the fiber-cement particles have been cured to an extent necessary for use in exterior building materials. This embodiment of a method can further include providing wood particles in addition to the fiber-cement particles, removing moisture from the fiber-cement particles, and combining the fiber-cement particles and the wood particles with a polymeric material to form a fiber-cement and polymer composite material.

Another embodiment of a method for manufacturing fiber-cement and polymer composite materials includes providing fiber-cement pieces that have been at least partially cured and are composed of silica, cement, and cellulose fibers. This embodiment of the method can further include producing fiber-cement elements from the fiber-cement pieces such that the fiber-cement elements are smaller than the fiber-cement pieces (e.g., the fiber-cement elements can have a maximum dimension not greater than about 1 inch and more commonly not more than about 0.5 inch). The method can further include compounding the fiber-cement elements with a polymer to form a fiber-cement and polymer composite. The compounding process, for example, can reduce the fiber-cement elements to smaller fiber-cement particles and remove moisture from the fiber-cement particles such that the compounded fiber-cement particles have a desired moisture content (e.g., not more than about 3% water by weight). In one embodiment, the fiber-cement particles can have maximum particle sizes of about 0.125 inch, but in many applications the maximum particle size of the fiber-cement particles is not more than 0.0625 inch.

Another aspect of the invention is directed toward methods for reusing fiber-cement that has been at least partially cured. An embodiment of such a method includes manufacturing a primary product from a fiber-cement material that has been at least partially cured and contains silica, cement, and cellulose fibers. The process of manufacturing the primary product results in waste fiber-cement pieces. The method can further include (a) reducing sizes of the waste fiber-cement to form fiber-cement particles that are at least partially cured, (b) controlling the moisture content of the fiber-cement particles, and (c) combining the fiber-cement particles, a polymer, and wood particles to form a fiber-cement and polymer composite material. The method can further include forming a building product from the fiber-cement and polymer composite material. For example, the building products can be floor tiles, decking pieces, roof shingles, stair treads, railings, siding materials, interior trim, exterior trim and other products.

Another aspect of the invention is directed toward fiber-cement and polymer compositions. One embodiment of such a composition comprises a polymeric matrix material and fiber-cement particles in the polymeric matrix material. The fiber-cement particles are composed of a fiber-cement waste material that has been at least partially cured and contains silica, cement, and cellulose fibers. The fiber-cement particles have not more than about 2% water by weight and are sized to be not greater than about 0.125 inch.

Another embodiment of a fiber-cement and polymer composition includes a polymeric matrix material, fiber-cement particles in the polymeric matrix material, and wood particles in the polymeric matrix material. The wood particles are in addition to the cellulose fibers of the fiber-cement particles. The fiber-cement particles are composed of a fiber-cement waste material that has been at least partially cured and contains silica, cement, and cellulose fibers. The fiber-cement particles are also sized to have maximum dimensions not greater than about 0.125 inch, and they have about 2% or less water by weight.

Another aspect of the invention is directed toward building products that comprise a body including a composite material having a polymeric matrix and fiber-cement particles in the polymeric matrix. The fiber-cement particles are composed of a fiber-cement waste material that has been at least partially cured and contains silica, cement, and cellulose fibers. The fiber-cement particles are sized to have maximum dimensions not greater than about 0.125 inch, and they have about 2% or less water by weight. The building product can further include wood particles in the polymeric matrix material. The body of the building product has a top surface configured to be an exterior surface and a bottom surface opposite the top surface.

Additional aspects of the invention are directed toward composite materials that include at least partially cured cement-containing particles dispersed in a matrix material. These aspects of the invention are not necessarily limited to fiber-cement particles, but rather the cement-containing particles can include cement without cellulose fibers. In other embodiments, these cement-containing particles are fiber-cement particles. One embodiment of such a composite material includes a polymeric matrix and cement-containing particles that have been at least partially cured dispersed in the polymeric matrix.

Another embodiment of the invention is directed toward a building product formed from a composite material that includes a polymeric matrix and cement-containing particles that are at least partially cured. The building products, for example, can be floor tiles, decking pieces, roofing shingles, stair treads, railings, siding materials, interior trim materials, exterior trim materials, and other products.

Still another embodiment of the invention is directed to a method of fabricating a composite material. In this embodiment, the method includes mixing cement-containing particles that have been at least partially cured with a polymeric material. The method can further include curing the polymeric material.

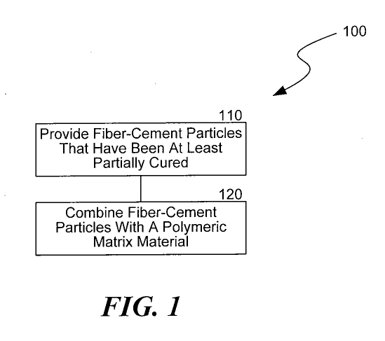

Many specific details of the invention are described below with reference to composite materials containing fiber-cement or types of cement-containing particles and a polymer to recycle cement-containing materials for use in building products, but they can also be used in other applications. Several embodiments in accordance with the invention are set forth in FIGS. 1-6 and the following text to provide a thorough understanding of particular embodiments of the invention. A person skilled in the art will understand, however, that the invention may have additional embodiments, or that the invention may be practiced without several of the details of the embodiments shown in FIGS. 1-6.

### B. Methods for Manufacturing Composite Materials and Building Products Including Fiber-Cement and at Least One Polymer

FIG. 1 is a flow chart illustrating a method 100 in accordance with an embodiment of the invention. In this embodiment, the method 100 includes providing fiber-cement particles that have been at least partially cured (Block 110). The fiber-cement particles can be fully cured in many applications, or the fiber-cement particles can be only partially cured in other applications. The fiber-cement particles include silica, cement, and cellulose fibers. The fiber-cement particles, however, do not include asbestos. The method 100 further includes combining the fiber-cement particles with a polymeric matrix material to form a fiber-cement polymer composite material (Block 120). The fiber-cement and polymer composite material typically includes recycled fiber-cement and can be used for any number of exterior and/or interior building products.

The fiber-cement particles can be obtained from fiber-cement planks, fiber-cement panels, fiber-cement backing products, fiber-cement trim and/or punched-out portions of fiber-cement shake panels and fiber-cement soffit. In manufacturing fiber-cement siding and backing products, for example, fiber-cement planks and panels may break into pieces or not meet desired quality control criteria (e.g., moisture content, strength, brittleness, etc). Other types of fiber-cement waste are the portions of fiber-cement panels or planks that are punched-out or sheared away in the manufacturing of fiber-cement soffit and fiber-cement shake panels. All of these sources generally provide fiber-cement that is at least partially cured and contains a combination of silica, cement, and cellulose fibers. The cellulose fibers in the fiber-cement waste products are typically wood fibers or other types of organic materials that have been chemically treated. The fiber-cement waste products do not include asbestos because asbestos-based products are not viable at this point in time.

After obtaining the fiber-cement waste materials, the process of providing fiber-cement particles generally includes reducing the size of the fiber-cement waste materials to a suitable particle size for the fiber-cement and polymer composite material. In one embodiment in which the fiber-cement waste is from planks and/or panels, it is generally desirable that the pieces have sizes less than approximately 8 inches, and more preferably less than approximately 6 inches, before further processing. Large planks and/or panels may need to be initially processed to such sized pieces. The applicants have developed several procedures for further reducing the size of the waste fiber-cement pieces into fiber-cement particles. In one embodiment, the 6-8 inch pieces of planks and/or panels are reduced to fiber-cement elements in a first size reduction process, and then the fiber-cement elements are reduced to fiber-cement particles having smaller particle sizes in a second size reduction process. The first size reduction process, for example, can be grinding, crushing, punching, shearing, or cutting the larger fiber-cement pieces into fiber-cement elements having sizes of not more than approximately 1 inch and more commonly sizes of not more than about 0.5 inch. The second size reduction process can be a compounding process in which the fiber-cement elements are further reduced in size. The fiber-cement particles can have particle sizes of not more than approximately 0.125 inch and more commonly not more than approximately 0.0625 inch. As explained in more detail below, the compounding process can further include combining the fiber-cement particles with a polymer and optionally wood particles to form the fiber-cement and polymer composite. In another embodiment, the larger fiber-cement pieces from the panels and/or planks can be ground, crushed or cut directly from the larger piece sizes to the smaller particle sizes of the fiber-cement particles. The 6-8 inch pieces of waste fiber-cement can be ground in a hammer mill or crushed in a crusher to particle sizes that are not more than approximately 0.125 inch and more commonly not more that approximately 0.0625 inch in this second embodiment.

The procedure for reducing the size of the fiber-cement waste obtained from creating fiber-cement soffits and/or fiber-cement shake panels can be the same as those described above for fiber-cement waste obtained from planks and/or panels. In other embodiments, much of the fiber-cement waste from fiber-cement soffits and/or shake panels is already fairly small (e.g., fiber-cement elements less than approximately 1 inch or even less than 0.5 inch). In such cases the procedure for providing the fiber-cement particles can include grinding, crushing, cutting and/or compounding the smaller fiber-cement elements created from the manufacturing of fiber-cement soffits and fiber-cement shake panels.

In addition to reducing the size of fiber-cement waste materials to suitable particle sizes, other embodiments of the invention provide fiber-cement particles with desirable moisture content and/or other properties. In many applications, fiber-cement particles can have 8-20% water by weight because the particles absorb moisture from the atmosphere and/or the fiber-cement waste comes in contact with water. The present inventors have found it is desirable to have fiber-cement particles with a moisture content of approximately 0.5-5% water by weight because particles with higher moisture content can create pockets and steam during extrusion processing of fiber-cement polymer composite materials. In several applications, the moisture content of the fiber-cement particles is 2%-3% water by weight.

The procedure for combining the fiber-cement particles with a polymeric material set forth in Block 120 of the method 100 includes mixing the fiber-cement particles with a polymeric material. In one embodiment, the fiber-cement particles and the polymer are combined together in a compounding machine, such as a compounding extruder, that forms pellets including the fiber-cement particles in a polymeric matrix material. As noted above, the compounding extruder can receive fiber-cement elements having sizes of approximately 0.5-1.0 inch. The compounding extruder further reduces the sizes of the fiber-cement elements to suitable particle sizes for the fiber-cement particles and mixes the fiber-cement particles with the polymeric material. In addition to grinding the fiber-cement waste into suitable final particle sizes, the compounding extruder also imparts enough heat to the mixture to steam-off or otherwise remove moisture from the fiber-cement particles and/or other components in the mixture. The pellets of the fiber-cement and polymer composite can then be used to form building products or other products in separate processes.

In another embodiment, fiber-cement particles having suitable particle sizes can be combined with a polymeric matrix material in a separate mixing process apart from an extruder. For example, the polymeric material can be in a dry or liquid state, and the fiber-cement particles can be mixed with the polymeric material in a desired dispersion. The mixture can then be processed to form pellets of the polymeric matrix material and/or final products of the fiber-cement and polymer composite.

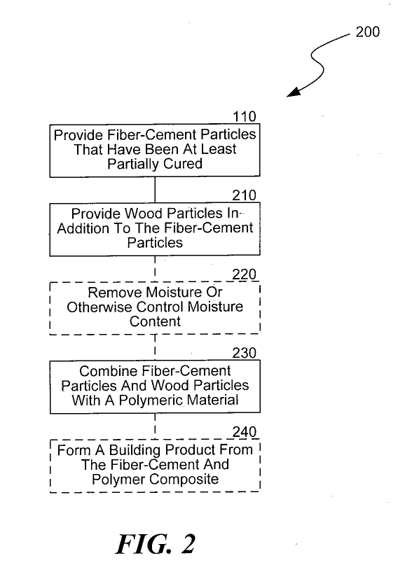

FIG. 2 is a flow chart illustrating a method 200 in accordance with another embodiment of the invention, and like reference numbers refer to like components in FIGS. 1 and 2. The method 200 can include providing fiber-cement materials that have been at least partially cured using any of the procedures described above with reference to Block 110 of the method in FIG. 1. The method 200 can further include providing wood particles in addition to the fiber-cement particles (Block 210). The wood particles are separate from the cellulose fibers in the fiber-cement particles. In several embodiments, the wood particles are wood flour, sawdust or other types of wood particles that have not been chemically treated. The method 200 can optionally include removing or otherwise controlling the moisture of the fiber-cement particles and/or the wood particles (Block 220). The moisture can be removed by heating the fiber-cement particles and/or the wood particles using infrared energy, heated gases, compounding the particles in a compounding extruder, and/or other drying processes that achieve a desired moisture content. The method 200 can further include combining the fiber-cement and the wood particles with a polymeric material (Block 230) and optionally forming a building product from the fiber-cement and polymer composite (Block 240). The fiber-cement particles and the wood particles can be combined with a polymeric material in Block 230 using a compounding extruder, a final extruder, or another mixing process.

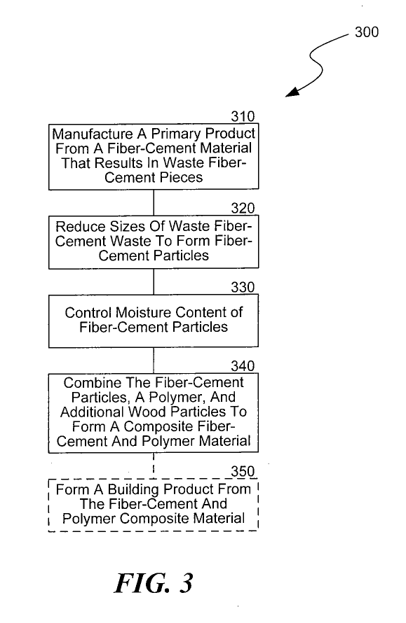

FIG. 3 is a flow chart of a method 300 in accordance with another embodiment of the invention, and like reference numbers refer to like components in FIGS. 1-3. The illustrated embodiment of the method 300 includes manufacturing a primary product from a fiber-cement material that results in waste fiber-cement pieces (Block 310). As explained above with reference to FIG. 1, the primary product can be fiber-cement siding planks, fiber-cement siding panels, fiber-cement backing materials, fiber-cement trim, fiber-cement soffits and/or fiber-cement shake panels. The waste fiber-cement pieces can accordingly include large pieces of fiber-cement panels and/or planks, or smaller fiber-cement elements.

The method 300 further includes reducing sizes of the fiber-cement waste pieces to form fiber-cement particles (Block 320). As described above, the fiber-cement waste pieces can be reduced by grinding or crushing the pieces directly into fiber-cement particles, or the fiber-cement pieces can be reduced to intermediately sized fiber-cement elements which are further reduced to smaller fiber-cement particles. The method 300 further includes controlling the moisture content of the fiber-cement particles (Block 330), which can be accomplished by heating the fiber-cement particles or fiber-cement elements using infrared radiation, heated gases and/or compounding the fiber-cement particles with a polymer and optionally with wood particles in a compounding extruder.

The method 300 further includes combining the fiber-cement particles, a polymer, and optional additional wood particles to form a composite fiber-cement and polymer material (Block 340). This procedure can be performed by mixing the fiber-cement particles, the wood particles and the polymeric materials separately from a compounding extruder. In other embodiments, the fiber-cement particles, the additional wood particles, and the polymeric material can be combined together in a compounding extruder to form pellets of the composite fiber-cement and polymer material. When the fiber-cement particles, polymeric material and wood fibers are combined in a compounding extruder, the procedures in Blocks 320, 330 and 340 can be performed concurrently. The compounding extruder, for example, can grind the fiber-cement to a final particle size and transfer heat to the fiber-cement that removes moisture while mixing the components together.

The method 300 can optionally include forming a building product from the fiber-cement and polymer composite material (Block 350). In one embodiment, fiber-cement and polymer composite decking materials (e.g., walking surfaces) are formed by extruding the fiber-cement and polymer composite materials through a final extruder separate from a compounding extruder. In other embodiments, other types of building products can be formed by extruding the composite fiber-cement and polymer material through an extruder. In still other embodiments, the fiber-cement and polymer composite material can be injection molded, cut, stamped, cast or otherwise formed into a building product.

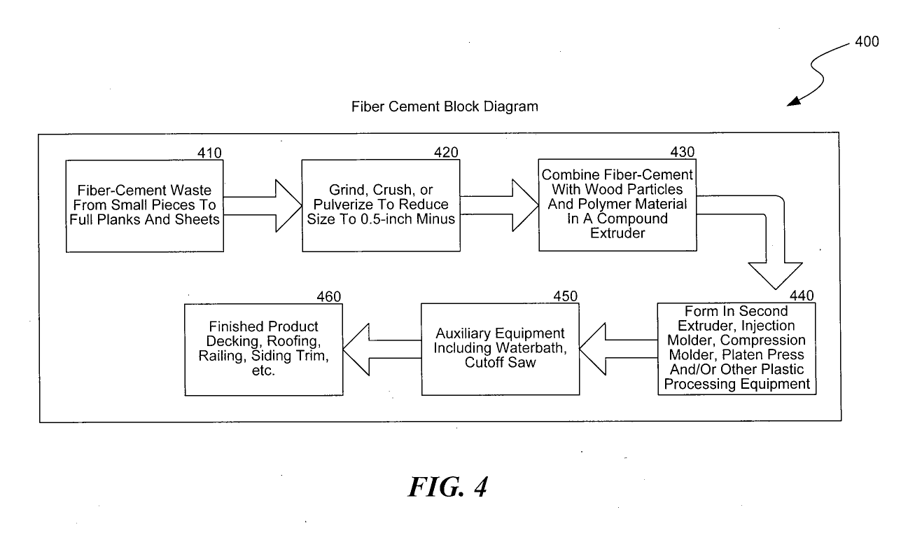

FIG. 4 is a flow chart of a specific method 400 for manufacturing a finished product from recovered or recycled fiber-cement waste material. In this embodiment, the method 400 includes providing fiber-cement waste that can include small pieces to full planks and sheets of a fiber-cement material which are at least partially cured and contain silica, cement, and cellulose fibers (Block 410). The method 400 further includes reducing the size of the fiber-cement waste to be 0.5 inch minus by grinding, crushing and/or pulverizing the fiber-cement waste (Block 420). The method 400 further includes combining the fiber-cement with a polymeric material by drawing and/or compounding the 0.5 inch minus fiber-cement waste with a polymer using commercial driers and/or a compounding extruder. In one specific embodiment, the 0.5 inch minus fiber-cement is combined with wood particles and a polymeric material in a compound extruder that further reduces the sizes of the fiber-cement to particle sizes of not more than 0.125 inch and more commonly not more than 0.0625 inch. The procedure of combining the fiber-cement with the polymeric material in a compound extruder can define a first extrusion procedure of the method 400. The method 400 further includes forming a body for a building product by processing the fiber-cement and polymer composite material in an extruder, injection molder, compression molder, press and/or other plastic processing equipment (Block 440). The procedure in Block 440 can accordingly be a second extrusion process of the method 400. The method 400 can optionally include processing the building product in a water bath, cut off saw or other auxiliary equipment (Block 450) to produce a finished product for decking, roofing, railings, siding trim, stair treads, or other building products (Block 460).

### C. Fiber-Cement and Polymer Compositions

The methods described above with reference to FIGS. 1-4 produce fiber-cement and polymer composites having various compositions. The polymeric materials can include, but are not limited to, thermoplastic and thermosetting polymeric materials. Specific examples of such materials include high density polyethylene (HDPE), polyvinyl chloride (PVC), nylon, epoxies, fiber-glass, acrylonitrle styrene acrylate (ASA), any combinations of these materials, or other suitable reinforced or non-reinforced polymeric materials. The following examples of fiber-cement and polymer composites are provided to set forth a better understanding of suitable compositions in accordance with embodiments of the invention, but other compositions can be suitable as well.

### 1. EXAMPLE ONE

A fiber-cement and polymer composite including 25%-80% by weight of fiber-cement particles, 20%-40% by weight of a polymeric material, and 25%-80% by weight of additional wood fibers. The fiber-cement particles are at least partially cured and can have particle sizes not more than 0.125 inch and more commonly not more than 0.0625 inch. The wood fibers can be wood flour, sawdust, or other wood fibers added in addition to the cellulose fibers of the fiber-cement particles. This example can also include additional components.

### 2. EXAMPLE TWO

A fiber-cement and polymer composite including 30%-50% by weight of fiber-cement particles, 20%-30% by weight of a polymeric material, and 30%-50% by weight of wood fibers. The fiber-cement particles are at least partially cured and can have particle sizes of not more than 0.125 inch and more commonly not more than 0.0625 inch. The wood fibers can be wood flour, sawdust or other suitable wood fibers that are added in addition to the cellulose fibers of the fiber-cement particles. This example can also include additional components.

### 3. EXAMPLE THREE

A fiber-cement and polymer composite having 30%-40% by weight of fiber-cement particles, 20%-30% by weight of a polymeric material, 30%-40% by weight of wood fibers, 1%-5% by weight of a dye or other type of color, and 1%-10% by weight of a lubricant. Suitable dyes or colors include single pigment dyes and custom color additive master batches, including, but not limited to, UV stabilizers, antioxidants, pH buffers, nucleating agents and compatibilizers. Additionally, suitable lubricants include, but are not limited to, zinc stearate, calcium stearate, magnesium stearate, aluminum stearate, and other types of metallic stearates. The fiber-cement particles are at least partially cured and can have particle sizes of not more than 0.125 inch and more commonly not more than 0.05 inch. The wood particles can be wood flour, sawdust or other suitable types of wood fibers in addition to the cellulose fibers of the fiber-cement particles. This example can also include additional components.

### 4. EXAMPLE FOUR

A fiber-cement and polymer composite including approximately 35% by weight fiber-cement particles, approximately 25% by weight of a polymeric material, approximately 35% by weight wood fibers, approximately 2% by weight of a color, and approximately 3% by weight of a lubricant. The fiber-cement particles are at least partially cured before mixing and can have particle sizes not more than 0.125 inch and more commonly not more than 0.0625 inch. Additionally, the wood fibers can be wood flour, sawdust or other suitable types of wood fibers in addition to the cellulose fibers of the fiber-cement particles. This example can also include additional components.

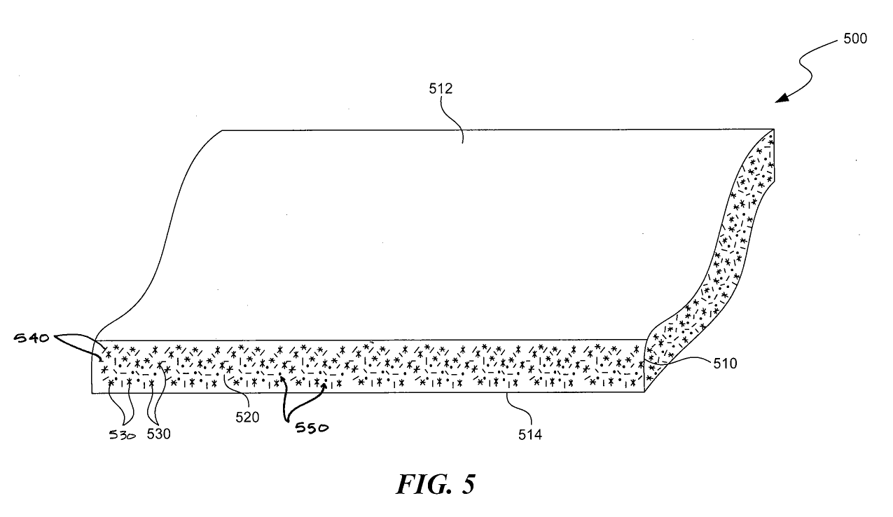

FIG. 5 is a schematic view of a portion of a building product 500 made in accordance with any of the foregoing methods and compositions described above with reference to FIGS. 1-4 and Examples 1-4. The building product 500 can include a body 510 having a first surface 512 and a second surface 514. The body 510 can be formed from a fiber-cement and polymer composite having a polymeric material 520, fiber-cement particles 530, and wood fibers 540. The fiber-cement particles 530 and the wood fibers 540 are distributed in the polymeric material 520 and can be any of the embodiments, or any combination of the embodiments, described above with reference to FIGS. 1-4 and Examples 1-4. The building product 500 can also include additives 550, such as dyes or pigments that impart a desirable color, UV inhibitors that protect the polymeric material from UV radiation, biocides that inhibit or prevent molds and/or mildews, insecticides that repel insects, and/or other types of additives.

The fiber-cement and polymer composite materials, and building products made from such composite materials, can have excellent fire resistance. Compared to wood and polymer composites that do not include fiber-cement particles, burn rate data regarding the fiber-cement and polymer composite set forth above suggests that they have excellent fire resistance. This is expected to be particularly useful for use in regions subject to brush fires or forest fires.

Several embodiments of the fiber-cement and polymer composites set forth above are also less subject to absorbing moisture and are more resistant to mildew compared to wood and polymer composites. The low-moisture fiber-cement particles in the fiber-cement polymer composite material do not absorb as much moisture as wood particles. Additionally, mildew does not eat cement such that the fiber cement particles are less subject to mildew growth. Therefore, many embodiments of building products and other types of products made from the foregoing fiber-cement and composite materials are highly suitable for use in wet or humid environments.

Several embodiments of fiber-cement and polymer composite materials in accordance with the embodiments set forth above also provide a good balance between structural strength, fire rating, weight and a reasonable consumption of fiber-cement waste material. For example, the fiber-cement and polymer composites are less brittle and lighter than cement and polymer composite materials without any fiber-cement. Moreover, adding wood fibers to the fiber-cement and polymer composite provides additional strength without adversely affecting the fire resistance and moisture absorbing properties of the building products.

Several embodiments of the foregoing fiber-cement and polymer composites may also provide better color retention compared to wood and polymer composites. Some studies suggest that fiber-cement and polymer composites can provide good color retention in particular spectrums (e.g., yellow). Therefore, several embodiments of the fiber-cement and polymer composite are very useful for building products in regions with high UV exposure.

### D. Additional Examples of Cement and Polymer Composite Materials and Methods of Making Such Materials

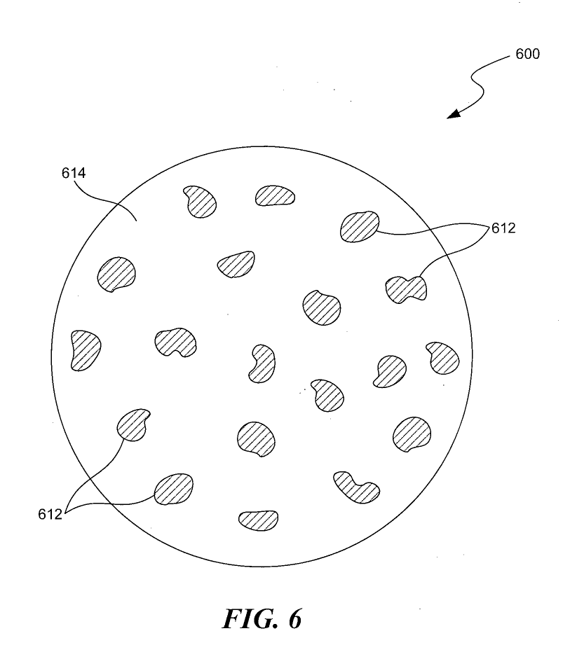

FIG. 6 is a schematic cross-sectional view of a composite material 610 according to still another embodiment of the invention. The composite material 610 includes a plurality of cured or at least partially cured cement-containing particles 612 dispersed in a polymeric matrix 614. The cement-containing particles 612 can be formed of fiber-cement particles ground from fiber-cement waste products, concrete cement particles ground from concrete products, or combinations thereof.

The polymeric matrix 614 binds the cement-containing particles 612 together to form the composite material 610 and may be selected from a variety of different materials. Examples of suitable materials for the polymeric matrix 614 include, but are not limited to, thermoplastic and thermosetting polymeric materials, such as high density polyethylene (HDPE), polyvinyl chloride (PVC), nylon, epoxies, fiber-glass, acrylonitrile styrene acrylate (ASA), combinations thereof, or another suitable reinforced or non-reinforced polymeric material. The composite material 610 may also include a number of different functional additives. In one embodiment, the additive is an ultraviolet (UV) inhibitor that prevents or inhibits deterioration of the polymeric matrix 614 caused by UV radiation from the sun. In another embodiment, the additive is a biocide that inhibits or prevent mold and/or mildew growth on or in the composite material 610. In yet another embodiment, the additive is a dye that imparts a desired color to the composite material 610. One or more of the above additives may be used in combination with each other to control the physical, chemical and/or aesthetic characteristics of the polymeric matrix 614. In some embodiments, in addition or as an alternative to the above functional additives, the composite material 610 may include fine sawdust particles (i.e., wood particles) dispersed through the polymeric matrix 614 to selectively tailor certain characteristics of the composite material 610, such as formability and other mechanical properties (e.g., strength).

The composite material 610 may be used in a variety of different applications for building products. In various embodiments, the composite material 610 may be formed into a floor tile, decking piece, roof shingle, stair tread, railings, siding, interior trim, and exterior trim. In one particular embodiment where the composite material 610 is fabricated into a decking piece, such as a plank, it may be used to replace currently available composite wood products formed of a polymeric matrix and wood particles. A decking piece or another building product formed of the composite material 610 having the cement-containing particles 612 dispersed through the polymeric matrix 614 is more resistant to fire, mold and mildew than conventional composite wood products or pressure treated wood. In such an embodiment, it may be desirable to also distribute sawdust particles in addition to the cement-containing particles 612 to provide the desired properties to the composite material 610. Additionally, unlike conventional pressure treated wood, which typically uses arsenic for the pressure treating, the composite material 610 does not need such chemical treatments. As such, articles made from the composite material are expected to be more environmentally compatible than such chemically treated products.

One composition for the composite material 610 suitable for use as a decking piece or another building product application is about 30 to about 35 weight percent HDPE for the polymeric matrix 614 and the balance being ground fiber-cement particles having a size about 200 microns (i.e., about 40 through about 60 mesh) to about 0.0625 inch (and, if present, wood particles and/or small amounts of additives. When the cement-containing particles are composed of fiber-cement, the present inventors have found that particle sizes of about 0.0625 are sufficient and offer several advantages. For example, such particles can be formed in a compounding extruder that eliminates dust and reduces process time. Additionally, even when ground or crushed, less dust is produced in making particles with sizes of 0.0156-0.0625 inch compared to very small particles of 200-360 microns. The larger particles of fiber-cement also pass through sizing meshes well, whereas very small fiber-cement particles of 200-360 microns may clog meshes.

Products may be fabricated from the composite material 610 using a variety of techniques, such as extruding, injection molding, and casting. In one embodiment of a method of extruding the composite material 610, the cured or at least partially cured cement-containing particles 612 are ground using a hammer mill or another suitable milling apparatus. The cement-containing particles 612 may be ground from concrete or fiber-cement waste generated during fabrication of other products such as fiber-cement siding as explained above. The ground cement-containing particles 612 are mixed with a powdered polymeric binder, which may be formed of any of the above polymeric materials suitable for the polymeric matrix 614. The mixture of cement-containing particles 612 and polymeric binder are heated and extruded through a die to a desired geometric configuration. The extruded product is cooled by spraying chilled water thereon to cure the polymeric matrix 614. The cooled extrusion may be cut to a selected size. This procedure is also applicable to any of the embodiments described above with reference to FIGS. 1-4.

In one embodiment of a method of injection molding the composite material 610, the cured or at least partially cured cement-containing particles 612 are ground as previously mentioned and mixed with a powdered polymeric binder that may be formed of any of the above polymeric materials suitable for the polymeric matrix 614. The mixture of cement-containing particles 612 and the polymeric binder is heated and injected into a die of an injection molding apparatus to form a molded product having a desired geometric configuration. The polymeric matrix 614 is allowed to cool to cure. This procedure is also applicable to any of the embodiments described above with reference to FIGS. 1-4.

In an embodiment of a method of casting the composite material 610, the cured or at least partially cured cement-containing particles 612 are ground as previously mentioned and mixed with a powdered polymeric binder that may be formed of any of the above polymeric materials suitable for the polymeric matrix 614. The mixture of cement-containing particles 612 and the polymeric binder may be heated to a sufficient temperature to cause the binder to flow and the mixture is poured into a die. The mixture is allowed to cure to form a product having a desired shape. This procedure is also applicable to any of the embodiments described above with reference to FIGS. 1-4.

Although the invention has been described with reference to the disclosed embodiments, persons skilled in the art will recognize that changes may be made in form and detail without departing from the spirit and scope of the invention. Such modifications are well within the skill of those ordinarily skilled in the art. Accordingly, the invention is not limited except as by the appended claims.

1. A method for manufacturing a fiber-cement and polymer composite material, comprising:
providing fiber-cement particles composed of silica, cement and cellulose fibers, wherein the fiber-cement particles are at least partially cured;
providing wood particles in addition to the fiber-cement particles;
removing moisture from the fiber-cement particles; and
combining the fiber-cement particles and the wood particles with a polymeric material to form a fiber-cement and polymer composite material.

2. The method of claim 1 wherein providing fiber-cement particles comprises obtaining fiber-cement pieces that are at least partially cured and reducing sizes of the fiber-cement pieces to fiber-cement elements having sizes not more than approximately 0.5 inch.

3. The method of claim 2 wherein reducing sizes of the fiber-cement pieces comprises punching out fiber-cement elements in the manufacturing of fiber-cement shake panels and/or fiber-cement soffits and further reducing sizes of the punched-out fiber-cement elements to form the fiber-cement particles.

4. The method of claim 3 wherein further reducing sizes of the punched-out fiber-cement elements to form the fiber-cement particles also includes removing moisture from the fiber-cement particles by compounding the punched-out fiber-cement elements with the polymeric material in a compounding extrusion process.

5. The method of claim 3 wherein further reducing sizes of the punched-out fiber-cement elements to form the fiber-cement particles comprises grinding the punched-out fiber-cement elements.

6. The method of claim 3 wherein further reducing sizes of the punched-out fiber-cement elements comprises crushing the punched-out fiber-cement elements.

7. The method of claim 2 wherein reducing sizes of the fiber-cement pieces comprises grinding the fiber-cement pieces to produce fiber-cement particles having particle sizes not more than about 0.0625 inch.

8. The method of claim 7 wherein grinding the fiber-cement pieces comprises processing the fiber-cement pieces in a hammer mill.

9. The method of claim 2 wherein reducing sizes of the fiber-cement pieces comprises crushing the fiber-cement pieces to produce fiber-cement particles having particle sizes not more than about 0.0625 inch.

10. The method of claim 1 wherein removing moisture from the fiber-cement particles comprises heating the fiber-cement particles.

11. The method of claim 10 wherein heating the fiber-cement particles comprises passing a heated gas across the fiber-cement particles.

12. The method of claim 10 wherein heating the fiber-cement particles comprises compounding the fiber-cement particles with the polymeric material and the wood fibers in a compounding extruder.

13. The method of claim 1 wherein the fiber-cement particles comprise 25%-80% by weight, the polymeric material comprises 20%-40% by weight, and the wood fibers comprise 25%-80% by weight.

14. The method of claim 1 wherein the fiber-cement particles comprise 30%-50% by weight, the polymeric material comprises 20%-30% by weight, and the wood fibers comprise 30%-50% by weight.

15. The method of claim 1 wherein the fiber-cement particles comprise approximately 30%-40% by weight, the polymeric material comprises approximately 20%-30% by weight, the wood fibers comprise approximately 30%-40% by weight, and the composite fiber-cement polymeric material further comprises a color of approximately 1%-5% by weight and a lubricant of approximately 1%-10% by weight.

16. The method of claim 1 wherein the fiber-cement particles comprise approximately 35% by weight, the polymeric material comprises approximately 25% by weight, the wood fibers comprise approximately 35% by weight, and the composite fiber-cement polymeric material further comprises a color of approximately 2% by weight and a lubricant of approximately 3% by weight.

17. A method for manufacturing a fiber-cement and polymer composite material, comprising:
providing asbestos free fiber-cement pieces that have been at least partially cured and are composed of silica, cement and cellulose fibers;
producing fiber-cement elements from the fiber-cement pieces; and
compounding the fiber-cement elements with a polymer to form a fiber-cement and polymer composite, wherein the compounding process reduces the fiber-cement elements to smaller fiber-cement particles and removes moisture from the fiber-cement particles such that the compounded fiber-cement particles have not more than about 3% water by weight.

18. The method of claim 17 wherein the fiber-cement particles comprise 25%-80% by weight, the polymeric material comprises 20%-40% by weight, and the wood fibers comprise 25%-80% by weight.

19. The method of claim 17 wherein the fiber-cement particles comprise 30%-50% by weight, the polymeric material comprises 20%-30% by weight, and the wood fibers comprise 30%-50% by weight.

20. The method of claim 17 wherein the fiber-cement particles comprise approximately 30%-40% by weight, the polymeric material comprises approximately 20%-30% by weight, the wood fibers comprise approximately 30%-40% by weight, and the composite fiber-cement polymeric material further comprises a color of approximately 1%-5% by weight and a lubricant of approximately 1%-10% by weight.

21. The method of claim 17 wherein the fiber-cement particles comprise approximately 35% by weight, the polymeric material comprises approximately 25% by weight, the wood fibers comprise approximately 35% by weight, and the composite fiber-cement polymeric material further comprises a color of approximately 2% by weight and a lubricant of approximately 3% by weight.

22. A method of reusing fiber-cement that has been at least partially cured, comprising:
manufacturing a primary product from a fiber-cement material that has been at least partially cured and contains silica, cement and cellulose fibers, wherein manufacturing the primary product results in waste fiber-cement;
reducing sizes of the waste fiber-cement to form fiber-cement particles that are at least partially cured;
controlling the moisture content of the fiber-cement particles;
combining the fiber-cement particles, a polymer, and wood particles to form a fiber-cement and polymer composite material; and
forming a building product from the fiber-cement and polymer composite material.

23. The method of claim 22 wherein reducing sizes of the waste fiber-cement to form fiber-cement particles comprises grinding the waste fiber-cement to produce fiber-cement particles having particle sizes not more than about 0.0625 inch.

24. The method of claim 23 wherein grinding the waste fiber-cement comprises processing the waste fiber-cement in a hammer mill.

25. The method of claim 22 wherein reducing sizes of the waste fiber-cement to form fiber-cement particles and combining the fiber-cement particles with a polymer and wood particles comprises processing the waste fiber-cement, the polymer, and the wood particles together in a compounding extruder.

26. The method of claim 22 wherein controlling the moisture content of the fiber-cement particles comprises heating the fiber-cement particles.

27. The method of claim 26 wherein heating the fiber-cement particles comprises at least one of passing a heated gas across the fiber-cement particles, imparting infrared energy to the fiber-cement particles, and/or placing the fiber-cement particles in an oven.

28. The method of claim 22 wherein removing moisture from the fiber-cement particles comprises compounding the fiber-cement particles with the polymer and the wood particles in a compounding extruder.

29. The method of claim 22 wherein the fiber-cement particles comprise 25%-80% by weight, the polymeric material comprises 20%-40% by weight, and the wood fibers comprise 25%-80% by weight.

30. The method of claim 22 wherein the fiber-cement particles comprise 30%-50% by weight, the polymeric material comprises 20%-30% by weight, and the wood fibers comprise 30%-50% by weight.

31. The method of claim 22 wherein the fiber-cement particles comprise approximately 30%-40% by weight, the polymeric material comprises approximately 20%-30% by weight, the wood fibers comprise approximately 30%-40% by weight, and the composite fiber-cement polymeric material further comprises a color of approximately 1%-5% by weight and a lubricant of approximately 1%-10% by weight.

32. The method of claim 22 wherein the fiber-cement particles comprise approximately 35% by weight, the polymeric material comprises approximately 25% by weight, the wood fibers comprise approximately 35% by weight, and the composite fiber-cement polymeric material further comprises a color of approximately 2% by weight and a lubricant of approximately 3% by weight.

33. A fiber-cement and polymer composition, comprising:
a polymeric matrix material; and
fiber-cement particles in the polymeric matrix material that are composed of an asbestos free fiber-cement waste material that has been at least partially cured and contains silica, cement and cellulose fibers, wherein the fiber-cement particles have not more than about 2% water by weight and are sized to be not greater than about 0.125 inch.

34. The composition of claim 33 wherein the fiber-cement particles have particle sizes not greater than about 0.0625 inch.

35. (canceled)

36. The composition of claim 33 wherein the fiber-cement particles comprise 25%-80% by weight, the polymeric material comprises 20%-40% by weight, and the wood fibers comprise 25%-80% by weight.

37. The composition of claim 33 wherein the fiber-cement particles comprise 30%-50% by weight, the polymeric material comprises 20%-30% by weight, and the wood fibers comprise 30%-50% by weight.

38. The composition of claim 33 wherein the fiber-cement particles comprise approximately 30%-40% by weight, the polymeric material comprises approximately 20%-30% by weight, the wood fibers comprise approximately 30%-40% by weight, and the composite fiber-cement polymeric material further comprises a color of approximately 1%-5% by weight and a lubricant of approximately 1%-10% by weight.

39. The composition of claim 33 wherein the fiber-cement particles comprise approximately 35% by weight, the polymeric material comprises approximately 25% by weight, the wood fibers comprise approximately 35% by weight, and the composition further comprises a color of approximately 2% by weight and a lubricant of approximately 3% by weight.

40. A fiber-cement and polymer composition, comprising:
a polymeric matrix material;
fiber-cement particles in the polymeric matrix material, wherein the fiber-cement particles (a) are composed of a fiber-cement waste material that has been at least partially cured and contains silica, cement and cellulose fibers, (b) are sized to have maximum dimensions not greater than about 0.125 inch, and (c) have not more than about 2% water by weight; and
wood particles in the polymeric matrix material.

41. The composition of claim 40 wherein the fiber-cement particles are sized to have maximum dimensions not greater than about 0.0625 inch.

42. A building product, comprising a body including a composite material having a polymeric matrix material, fiber-cement particles in the polymeric matrix material, wherein the fiber-cement particles (a) are composed of a fiber-cement waste material that has been at least partially cured and contains silica, cement and cellulose fibers, (b) are sized to have maximum dimensions not greater than about 0.125 inch, and (c) have not more than about 2% water by weight, and wood particles in the polymeric material, wherein the body has a top surface configured to be an exterior surface and a bottom surface opposite the top surface.

43-82. (canceled)
